(19) United States
(12) Patent Application Publication
(10) Pub. No.: US 2006/0244175 A1
(43) Pub. Date: Nov. 2, 2006

(54) Direct coating method

(76) Inventor: Michael Horstmann, Neuwied (DE)

Correspondence Address: William F Lawrence;Frommer Lawrence & Haug, 745 Fifth Avenue, New York, NY, 10151, US

(21) Appl. No.: 10/558,902

(22) PCT Filed: May 6, 2004
(86) PCT No.: PCT/EP04/04792

§ 371 Date: Dec. 1, 2005

(30) Foreign Application Priority Data
Jun. 4, 2003 (DE) 103 25 140.5

(51) Int. Cl. B29C 41/26

(52) U.S. Cl. 264/212; 264/216; 425/224

(57) ABSTRACT

The invention relates to a method for producing self-solidifying film forming substances from initial liquid substances in a device designed for this purpose and to a corresponding device. The inventive method consists in coating an inert continuously advancing carrier in the form of the part of said device with initial substances (7, 13). A dosing device (25) makes it possible to adjust the thickness of said initial substances for coating the carrier. The coated carrier conveys a substance layer (23) to a drying device (30). The dried substance layer separates itself from the carrier or is removed therefrom. Said method makes it possible to produce self-solidifying film-forming gelatinous substances exhibiting a low material thickness variation from initial liquid substances.

The invention relates to a method for producing film-like solidifying substances from initially free-flowing starting substances in a suitably configured apparatus, and corresponding apparatus.

The substances are, for example, pharmaceutical preparations which solidify from an originally free-flowing state. They may, for example, contain pharmaceutical active ingredients and/or flavorings. As they dry, these materials may solidify in jelly style, for example thicken and solidify. The film-like end product may in this case be elastically or plastically deformable.

DE 101 21 972 A1 has disclosed a drying chamber in which a free-flowing substance which has been applied to a paper-like, polyethylene-coated carrier material in web form, is dried. This paper-like carrier material is expensive and can only be used once. Moreover, it brings with it the risk of infestation with insects or other impurities.

U.S. Pat. No. 4,562,020 has disclosed a method for drying glucose-containing solutions on an endless plastic belt. The thickness of the film which becomes detached from the plastic belt after it has dried varies considerably.

U.S. Pat. No. 4,306,059 has disclosed a method for producing a film in which a liquid substance is applied to a preheated, chromium-plated roller.

Therefore, the present invention is based on the object of developing an inexpensive method and an apparatus for producing film-like substances which solidify in jelly-like form with only minor deviations in the material thickness from free-flowing starting substances.

This problem is solved by the features of the main claim. For this purpose, a continuously moving, inert carrier which is part of the apparatus is coated with the starting substances. The thickness of the starting substances which coat the carrier is set by means of a metering apparatus. The coated carrier then moves the layer of substance through a drying device. After the drying operation has ended, the dried substance layer becomes detached or is detached from the carrier.

During the method, the inert carrier comes into contact with the starting substances without reacting with them. During this contact, the material of the carrier is not attacked or changed either chemically or physically or biologically.

The carrier may, for example, be a rotating roller or a continuous, endless belt, to which the starting substance is applied or which receives the starting substance. After the substance has dried on the carrier, it becomes detached or can be detached from the carrier. The carrier itself does not require any further treatment and can immediately be reused to receive further starting substances.

The thickness of the coating of the carrier is set by means of a metering apparatus. The metering apparatus may, for example, be an adjustable outlet opening of a reservoir, a metering roller, etc. If a metering roller is used, its distance from the inert carrier is adjustable, for example. A coating of at least approximately constant thickness is produced on the inert carrier. The end product has a uniform thickness. The deviations in the thickness in the longitudinal and transverse directions of the extent of the film are slight.

This method does not entail the use of any disposable material which would have to be purchased at high cost and then disposed of again following the production process. This makes the method inexpensive in particular in the case of intensively used manufacturing installations.

Further details of the invention will emerge from the sub-claims and the following description of diagrammatically depicted embodiments. In the drawing:

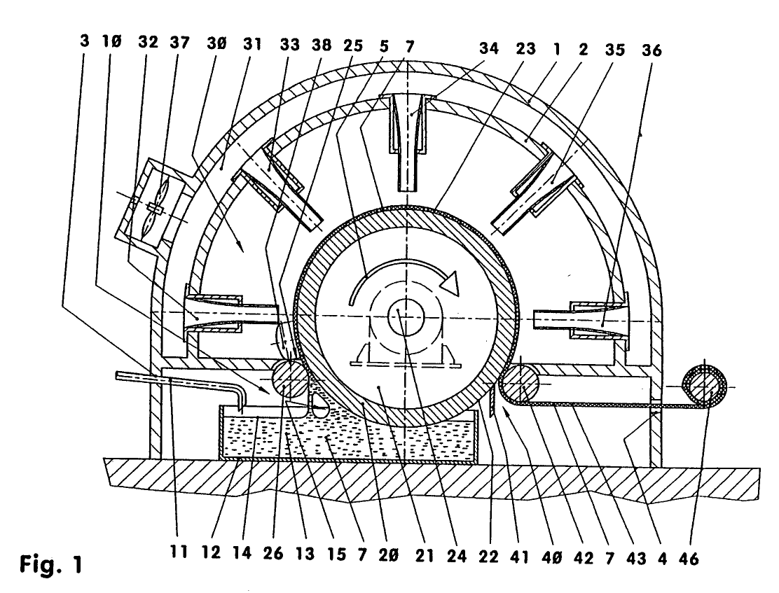

FIG. 1 shows a section through an apparatus for producing film-like substances;

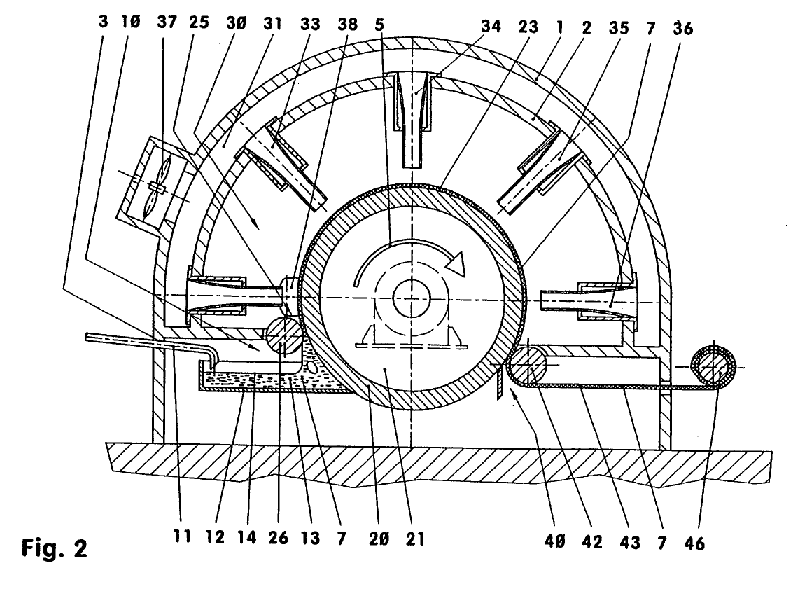

FIG. 2 shows a section through an apparatus having a different substance bath.

FIG. 1 shows a section through an apparatus for producing film-like substances (7, 43) from a free-flowing starting substance (7, 13).

The apparatus is arranged in a fixed outer housing (1) and comprises an application point (10), a carrier (20), a drying device (30) and a separation region (40).

At the application point (10), the free-flowing starting substance (7, 13) is applied to the carrier (20) as a substance layer (7, 23) metered by means of a metering apparatus (25). The substance layer (7, 23) is dried in the drying device (30). In the separation region (40) the substance layer becomes detached from the carrier (20) in the form of a film or is detached from the carrier and then fed as a film-like substance (7, 43) for further processing.

The application point (10) comprises, for example, a feed line (11), which is used to move a free-flowing starting substance (7, 13) which has been made up into a reservoir (12) arranged within the housing (1). The free-flowing starting substance (7, 13) may be enriched, for example, up to a solids content of 40%.

As an alternative to using a feed line (11), it is also possible for the starting substance (7, 13) to be made up directly in a reservoir (12), which is then inserted into the housing (1). It is also conceivable for it to be made up in a separate container which is in communication with the reservoir (12).

The carrier (20) is, for example, a roller (20) made from a metallic material which is resistant to chemical reactions and is physically durable. This material may, for example, be a corrosion-resistant steel.

The roller (20) is, for example, a hollow cylinder. Its external diameter is, for example, approximately three meters, and its length transversely to the delivery direction (5) is approximately 1.8 meter. At its end side is a drive unit (not shown here). This comprises, for example, an electric motor which, by way of example, drives the roller (20) via a transmission with a high step-up ratio.

The interior (21) of the roller (20) may have a heating-gas opening (24), which can be used, for example, to supply heated air for internally heating the roller (20).

The drying device (30) comprises a compressor (37) and a heater (not shown) as well as a distribution manifold (31) which is arranged between the outer housing (1) and an inner housing (2). By way of example five nozzles (32-36) are arranged in the inner housing.

Each of these nozzles (32-36) is oriented centripetally with respect to the roller (20), so that the individual nozzle (32-36) is in each case positioned perpendicular to an imaginary tangential plane on the surface (22) of the roller. The length of each individual nozzle (32-36) transversely with respect to the direction of movement (5) at least approximately corresponds to the length of the roller (20). The air distribution manifold (31) and the nozzles (32-36) forcibly guide a drying medium from the compressor at least onto the substance layer (7, 23) and then discharge it into a vent opening (38). From here, the drying medium can be fed back to the compressor (37), for example via devices for humidifying or dehumidifying the drying medium.

The air distribution manifold (31) may be of multi-part design. By way of example, each of the nozzles (32-36) can be supplied with specially treated drying medium. The drying medium which flows through the individual nozzles (32-36) can then, for example, have a different volumetric flow and/or a different temperature.

The separating region (40) comprises, for example, a separating apparatus (41) for peeling the substance layer (7, 23) off the roller (20) and, for example, a guide roller (42). The separating apparatus (41) is in the form, for example, of a blade which includes an acute angle with an imaginary tangential plane on the surface (22) of the roller (20).

At the start of production of the film-like substance (7, 43), the reservoir (12) is filled with free-flowing starting substance (7, 13) sufficiently far for the surface (22) of the roller (20) to be in contact with or submerged below the surface (14) of the starting substance (7, 13).

After the drive unit has been switched on, the roller (20) rotates, for example, at a constant rotational speed. The circumferential velocity of the surface (22) of the roller (20) is then, for example, 10 m/min.

The free-flowing starting substance (7, 13) is picked up from the reservoir (12) by the rotating roller (20) by wetting the latter, sticks to the roller as a coating and is carried along by the roller (20).

The metering apparatus (25) is arranged in the region of the application point (10). This metering apparatus comprises a metering or stripping roller (26), for example a doctor roller (26). The distance between this doctor roller (26) and the roller (20) is adjustable. This doctor roller (26) is used to distribute the starting substance (7, 13) which has been picked up uniformly over the surface (22) of the roller (20). Excess starting substance (7, 13) by way of example drips off a doctor grate and flows back into the reservoir (12).

Depending on the length of the roller (20), the metering roller (26) may be supported at one or more points by means of bearings. This prevents inaccuracies in the thickness of the substance layer (7, 23) caused by the metering roller (26) sagging. A parallel arrangement of a plurality of metering rollers (26) is also conceivable.

The remaining coating of the roller (20) is a substance layer (7, 23) with a constant thickness of, for example, 0.3 mm which adheres to the roller (20). As the rotation of the roller (20) continues, the substance layer (7, 23) is moved into the drying device (30). The drying device is separated from the reservoir (12) for example by a horizontal housing wall.

In the drying device (30), drying medium, for example dehumidified air, which has been heated to, for example, 95° C. is passed into the distributor manifold (31) by the compressor. The drying medium flows through the nozzles (32-36) perpendicularly onto the substance layer (7, 23) and if appropriate to a collector. In the process, moisture is withdrawn from the substance layer (7, 23) so that the latter is dried to a residual moisture content. The substance layer (7, 23) in the process solidifies in jelly-like form.

If the nozzles (32-36) are supplied separately, the drying operation can, for example, be controlled in such a way that, for example, more moisture is withdrawn in the region of the first nozzle (32) than in the region of the last nozzle (36) or vice versa.

As the moisture content of the substance layer (7, 23) decreases, by way of example its adhesion to the roller (20) decreases. After the drying operation has ended, below a substance-specific residual moisture content, the substance layer (7, 23) becomes detached from the roller (20). If appropriate, the start of the substance layer (7, 23) can be lifted off the roller (20) using the separating apparatus (41). The substance layer (7, 23) which has been lifted off the roller (20) is now a film-like substance (7, 43) which is conveyed to the winding roller (46) with the aid of the guide roller (42). From the winding roller (46), the film-like substance (7, 43) is passed for further processing, for example for cutting or dividing into lengths.

The roller (20) may be internally heated. It is in this way possible to accelerate the drying process of the substance (7, 23) on the roller (20) and to improve the way in which the film-like substance (7, 43) becomes detached from the roller (20).

The rotational speed of the roller (20) may be fixed or adjustable. By way of example, in the case of an installation on which different substances (7) are produced, it is possible to set specific circumferential velocities for each substance (7). The film-like substance (7, 43) then in each case has the required chemical and physical properties.

FIG. 2 shows an apparatus with a different substance bath. The reservoir (12) is in this case arranged in the fourth quadrant of the roller (20). The reservoir (12) is open toward the roller (20), so that the free-flowing starting substance (7, 13) bears directly against the roller (20). The bath of the starting substance (7, 13) is shallow, so that the starting substance (7, 13) has only a short residence time in the reservoir (7, 13) between flowing out of the feed line (11) and being picked up by the roller (20). This means that there is only a low risk of volatile constituents of the starting substance (7, 13) evaporating, and also reduces the risk of the starting substance (7, 13) decomposing.

### LIST OF DESIGNATIONS

1 Outer housing
2 Inner housing
3 Housing aperture
4 Housing aperture
5 Direction of movement
7 Substance
10 Application point
11 Feed line
12 Reservoir
13 Free-flowing starting substance
14 Surface of (13)
15 Coating
20 Carrier, roller
21 Interior of (20)
22 Surface of (20)
23 Substance layer
24 Heating gas opening
25 Metering apparatus
26 Metering roller, stripping roller, doctor roller
30 Drying device
31 Distribution manifold
32-36 Nozzles
37 Compressor
38 Vent opening
40 Separating region
41 Separation apparatus
42 Guide roller
43 Film-like substance
46 Winding roller

1. A method for producing film-like solidifying substances (7, 43) from initially free-flowing starting substances (7, 13) in a suitably configured apparatus,
in which a continuously moving, inert carrier (20), which forms part of the apparatus, is coated with the starting substances (7, 13),
in which the thickness of the starting substances (7, 13) which coat the carrier (20) is set by means of a metering apparatus (25),
in which the coated carrier (20) moves the substance layer (7, 23) through a drying device (30), and
in which the dried substance layer (7, 43) becomes detached or is detached from the carrier (20).

2. The method as claimed in claim 1, characterized in that a roller (20) is coated with the starting substances (7, 13).

3. The method as claimed in claim 2, characterized in that the roller (20) rotates at a constant circumferential velocity.

4. The method as claimed in claim 2, characterized in that the roller (20) is internally heated.

5. The method as claimed in claim 3, characterized in that the rotating roller (20) comes into contact with the free-flowing starting substance (7, 13) in a reservoir (12), picks up the free-flowing starting substance by being wetted with it, and then excess starting substance (7, 13) is stripped off by means of a metering apparatus (25).

6. The method as claimed in claim 1, characterized in that a drying medium is moved forcibly within the drying device (30) so that it flows perpendicularly onto the coated carrier (20).

7. The method as claimed in claim 6, characterized in that the drying medium which flows in is passed through at least two nozzles (32-36) oriented perpendicular to the carrier (20).

8. The method as claimed in claim 7, characterized in that the volumetric flow and/or the temperature of the drying medium which flows in from at least two nozzles (32-36) differs.

9. An apparatus for producing film-like, solidifying substances from free-flowing starting substances which comprises an application point for applying the starting substances to a moveable carrier, a metering apparatus for setting the thickness of the starting substances which coat the carrier, and a drying device for drying the starting substances, characterized in that the carrier (20) consists of a metallic material which is resistant to chemical reactions and is physically durable.

10. The apparatus as claimed in claim 9, characterized in that the carrier is a roller (20).

11. The apparatus as claimed in claim 9, characterized in that it comprises a housing (1, 2) in, which a drying medium is fed forcibly perpendicular to the carrier (20) and is discharged transversely with respect to the direction of movement (5).

12. The apparatus as claimed in claim 11, characterized in that the drying medium which flows in is passed through at least two nozzles (32-36) which are oriented perpendicular to the carrier (20), the length of the individual nozzle transversely to the direction of movement (5) at least approximately corresponding to the length of the carrier (20) transversely to the direction of movement (5).
